(19) United States
(12) Patent Application Publication
(10) Pub. No.: US 2016/0091155 A1
(43) Pub. Date: Mar. 31, 2016

(54) CHRISTMAS LIGHT STRINGS WITH BULB IDENTIFICATION FOR REPLACEMENT PURPOSES

(71) Applicant: JLJ, Inc., Bellbrook, OH (US)

(72) Inventor: John L. Janning, Bellbrook, OH (US)

(21) Appl. No.: 14/537,446

(22) Filed: Nov. 10, 2014

Related U.S. Application Data
(63) Continuation-in-part of application No. 14/524,619, filed on Oct. 27, 2014.
(60) Provisional application No. 62/071,696, filed on Sep. 30, 2014.

(51) Int. Cl. F21S 4/00; F21S 10/06

(52) U.S. Cl. CPC F21S 4/001; F21S 10/06; F21Y 2113/005

(57) ABSTRACT

A series wired light string which includes a marking on the bulb holder or socket of each light with the identity, i.e., current rating, of the bulb, or in the case of an LED light string, the color and/or current rating of the LED bulb, for replacement purposes. The identity marking can be applied to either or both of the bulb socket and holder, and can be added to the socket or holder during molding or afterwards by other means.

This application is a continuation-in-part of U.S. application Ser. No. 14/524,619, filed on Oct. 27, 2014, which claims priority to U.S. Provisional Application No. 62/071,696, filed on Sep. 30, 2014, the disclosures of which are herein incorporated by reference in their entireties.

### BACKGROUND OF THE INVENTION

1. Field of the Invention

The present invention relates to series wired light strings, such as used in Christmas decorative lighting and, more particularly, to an identity marking to facilitate the replacement of defective lights in the series-wired light string.

2. Description of the Related Art

Consumers of light strings are often frustrated in finding replacement lights (incandescent bulbs or LEDs) for Christmas light strings in which one or more lights are burned out or otherwise defective. The main problem for the consumer is determining the proper type of light bulb or LED for replacement—i.e., an incandescent bulb with the correct current rating or an LED of the correct color and current rating.

Not too long ago, there was only one type of incandescent bulb: a 2.5 volt incandescent bulb used in a 50 or 100-light string—it drew a current of 170 milliamperes (170 mA). Today, Christmas light strings use light bulbs with a variety of current ratings—85 mA; 100 mA; 135 mA; 170 mA; 200 mA—just to name a few. All are rated at 2.5 volts.

LED bulbs in various colors are also becoming increasingly popular for use in Christmas light strings. Color LEDs typically operate at 20 mA, but recently higher current rated LEDs with increased brightness are being used in light strings. The voltage drop across the LED varies according to the color of the LED. For example, a red LED only requires about 2 volts for illumination, while a blue LED requires about 3.4 volts.

As will be apparent to those skilled in the art, it is important, for safety reasons and for proper illumination of the light string, that replacement incandescent or LED bulbs inserted by consumers have the correct current rating and are the correct color.

Accordingly, it would be desirable to provide, on the light string, an indication to the user of the current rating and/or color of the incandescent or LED bulb to use as a replacement for a burned out or missing incandescent or LED bulb.

### SUMMARY OF THE INVENTION

The present invention provides an elegant but simple solution to the aforementioned replacement identity problem by providing a marking on the bulb holder or socket with the identity of the incandescent or LED bulb, specifying the current rating or color of the replacement incandescent bulb or LED. The identity marking can be applied to the bulb/LED holder or socket during molding or afterwards by other means.

Other advantages, variations and other features of the invention will become apparent from the drawings, the further description of examples and the claims to follow.

### BRIEF DESCRIPTION OF THE DRAWINGS

FIG. 1 illustrates the identity printed on a socket for an incandescent bulb.

FIG. 2 illustrates the identity printed on the holder of an incandescent bulb.

FIG. 3 shows that the identity can include both the voltage and current of the bulb, printed on opposite sides of the bulb holder.

FIG. 4 illustrates the identification of the color of the LED printed on the LED socket and the LED bulb holder.

FIG. 5 illustrates the identification of color on one side of the LED bulb holder, and identification of LED current on the opposite side of the LED bulb holder.

### DETAILED DESCRIPTION OF THE PREFERRED EMBODIMENTS

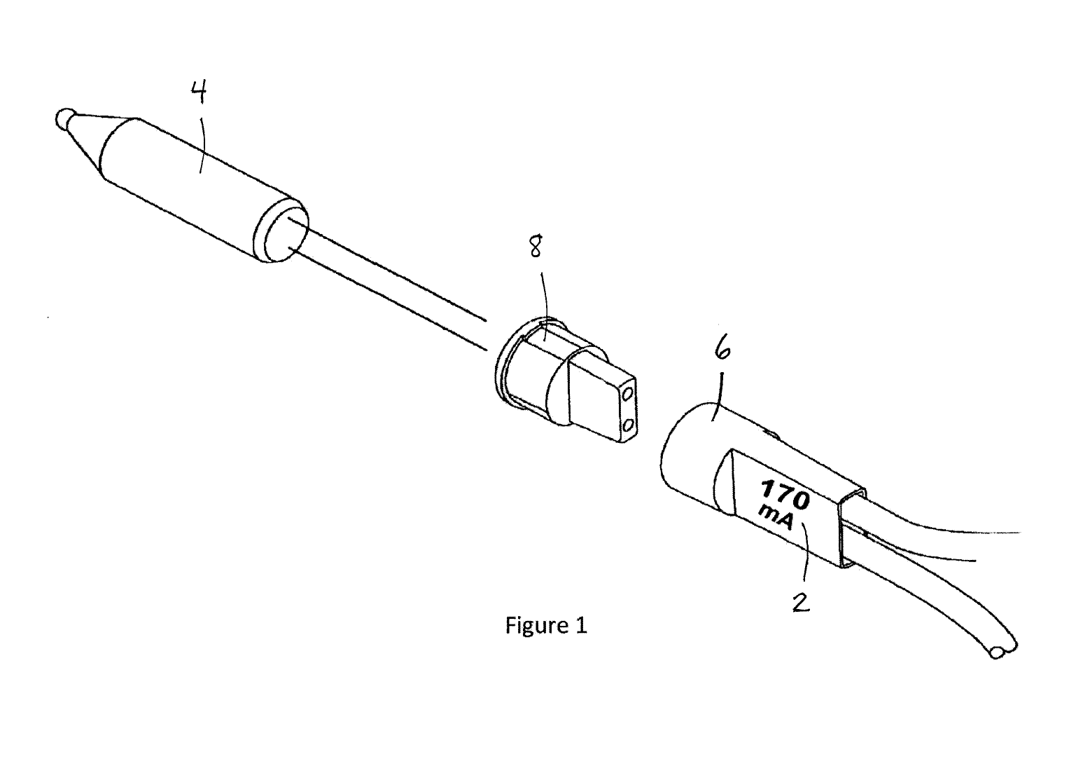

Referring now to the drawings, FIG. 1 shows an embodiment of the present invention in which the indicator 2 of the current rating of an incandescent bulb 4 is provided on the bulb socket 6. The current rating shown in FIG. 1 is 170 mA only as an example. The indication of the current rating can be applied to the socket in any of a number of ways. For example, the numbers/characters can be raised in the molding or indented or recessed. If not molded, the characters/numbers of the bulb current rating can simply be printed onto the socket.

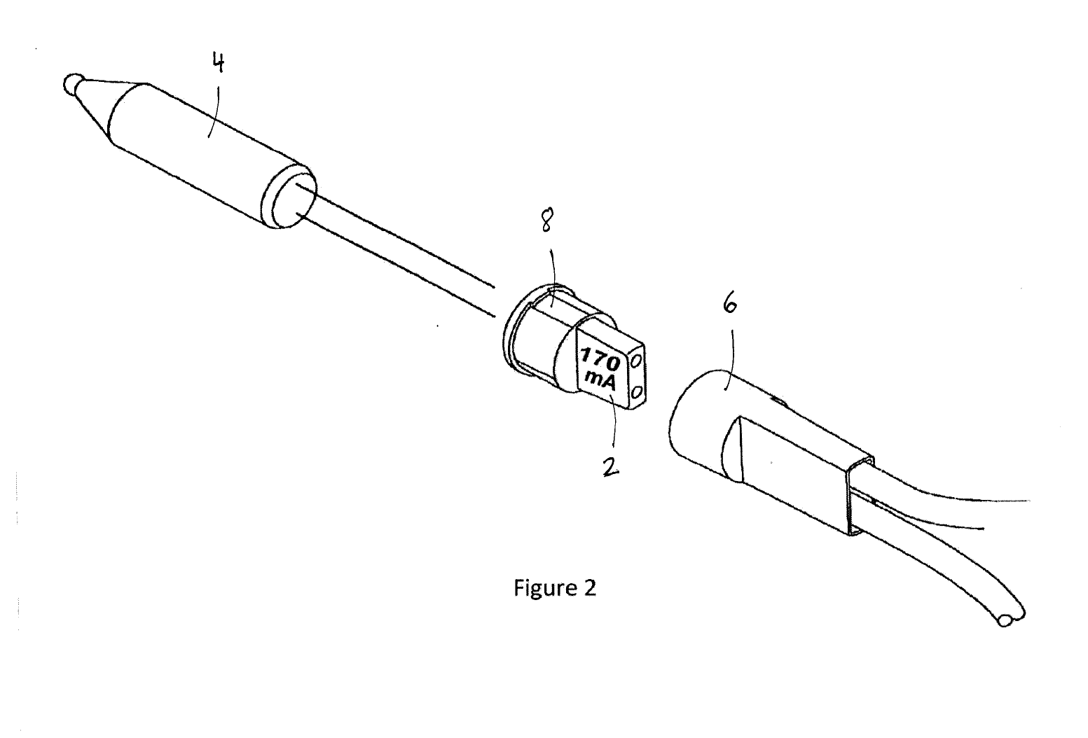

As shown in FIG. 2, the replacement bulb indicator 2 can alternatively (or in addition) be provided on the bulb holder 8. Again, the numbers/characters of the current rating can be raised/recessed in the bulb holder molding or simply printed onto the bulb holder 8.

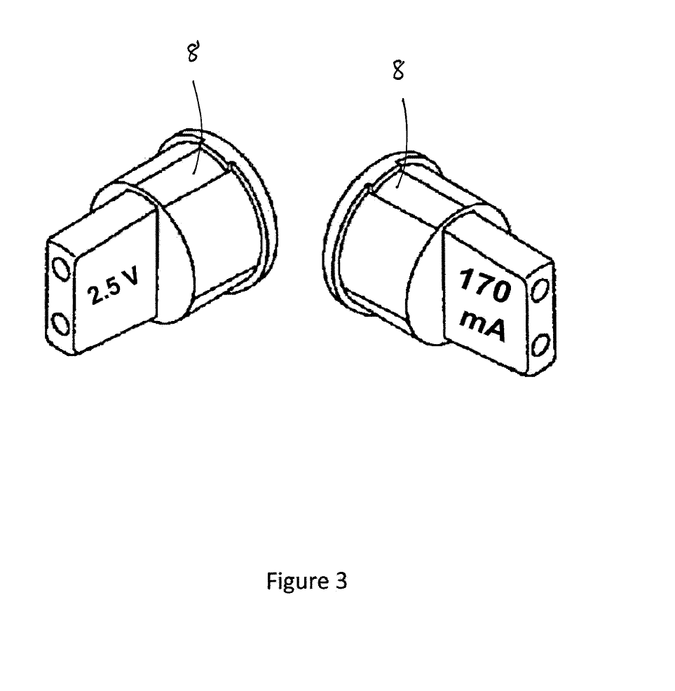

If desired, indicators of both the current rating and the voltage rating of the bulb can be provided, preferably on opposite sides of the bulb holder 8, as shown in FIG. 3, and/or on opposite sides of the bulb socket (not shown).

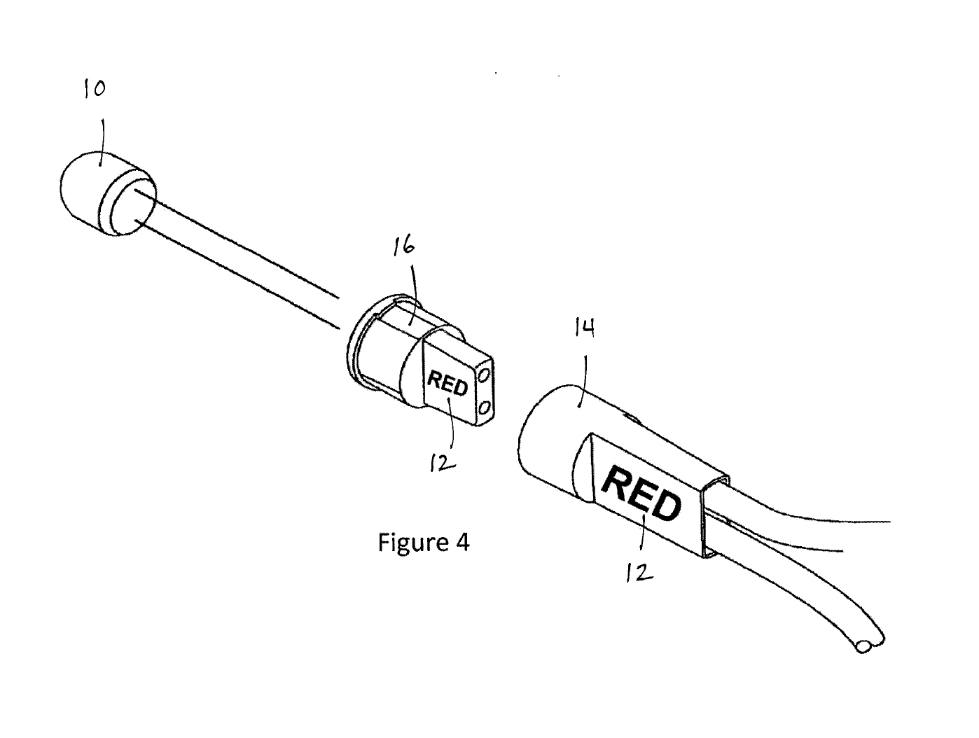

FIG. 4 shows an embodiment of the present invention for identifying the color of an LED bulb 10 in an LED light string. The color of the LED is identified in lettering 12 (possibly colored itself) on the LED socket 14 and/or the LED holder 16. It is important for the consumer to replace an inoperative LED bulb with a replacement LED bulb of the same current rating and the same color to ensure proper voltage drop across the string.

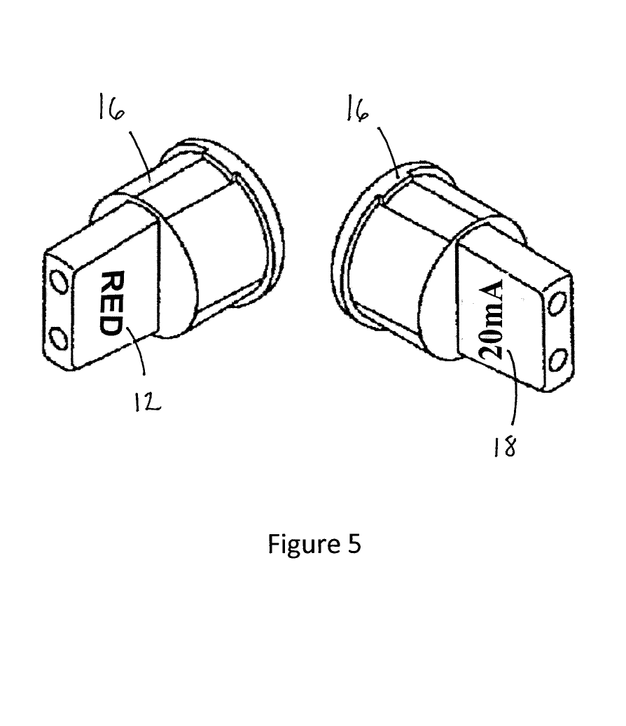

Some manufacturers are starting to use LED bulbs with higher than the standard 20 mA to increase brightness. Therefore, the bulb type identification for such is shown in FIG. 5. On one side of the bulb holder, the LED color 12 is identified, and on the opposite side of the bulb holder, the LED current rating 18 is identified. Different identification characters could also be used.

The present invention advantageously simplifies the replacement of defective incandescent or LED bulbs in a series-wired light string, by providing consumers with an identification of the current rating of the bulb to be replaced, or the color of the inoperative LED to be replaced. The present invention thus increases the safety of bulb replacement by consumers.

The present invention can also advantageously be used to identify different types of bulbs. For example, the socket or holder for an incandescent or LED bulb could be marked with FLSHR to identify a flasher bulb.

Although the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

1. A light string comprising a plurality of light units connected in electrical series, each unit comprising a socket, a bulb holder and a bulb, the bulb having a current rating and a color, wherein the bulb holder includes an identification of at least one of the current rating of the bulb or the color of of the bulb for bulb replacement purposes.

2. A light string as recited in claim 1, wherein the light unit comprises an LED socket, an LED holder, and an LED bulb, the current rating of the LED bulb being provided on one side of the LED holder, and the color of the LED bulb being provided on an opposite side of the LED holder.

3. (canceled)

4. (canceled)

5. A light string as recited in claim 1, wherein the identification indicates that the bulb is a flasher bulb.
